(19) United States
(12) Patent Application Publication
(10) Pub. No.: US 2011/0193986 A1
(43) Pub. Date: Aug. 11, 2011

(54) IMAGE SENSING DEVICE

(75) Inventors: Kazuhiro KOJIMA, Higashiosaka City (JP); Haruo HATANAKA, Kyoto City (JP)

(73) Assignee: SANYO ELECTRIC CO., LTD., Osaka (JP)

(21) Appl. No.: 13/024,126

(22) Filed: Feb. 9, 2011

(30) Foreign Application Priority Data
Feb. 9, 2010 (JP) 2010-026821

(51) Int. Cl. H04N 5/228

(52) U.S. Cl. 348/222.1; 348/E05.031

(57) ABSTRACT

An image sensing device includes: a subject detection portion which detects a specific subject from a preview image; a state determination portion which determines the state of the specific subject detected by the subject detection portion; a sound output portion which outputs a sound to the specific subject when the state of the specific subject is determined not to be a first state; and a shooting portion which shoots a target image when the state of the specific subject is determined to be the first state.

This nonprovisional application claims priority under 35 U.S.C. §119(a) on Patent Application No. 2010-026821 filed in Japan on Feb. 9, 2010, the entire contents of which are hereby incorporated by reference.

### BACKGROUND OF THE INVENTION

1. Field of the Invention

The present invention relates to an image sensing device that shoots an optical image of a subject.

2. Description of Related Art

In recent years, digital cameras have been widely used, and hence they are used at various shoot scenes and in various applications. Some of these types of digital cameras have various shooting modes other than a normal shooting mode; in an example of the shooting modes, when the state of a subject is determined to be a state in which predetermined conditions are satisfied, shooting is automatically performed.

For example, a conventional image sensing device is formed such that an image in which a subject looks to the image sensing device, that is, an image in which the subject looks to a camera, can be acquired. In the image sensing device, when, from an image that includes either the face of a person or the faces of a plurality of persons, the direction of lines of sight thereof is detected, and then the lines of sight are determined to point to the image sensing device, the image is shot and stored.

However, for example, when a subject such as a child or an animal is shot, it is expected that it may be difficult for the subject to look to a camera. In this case, it is burdensome for a photographer to wait for the subject to look to the camera.

### SUMMARY OF THE INVENTION

An image sensing device according to the present invention includes: a subject detection portion which detects a specific subject from a preview image; a state determination portion which determines the state of the specific subject detected by the subject detection portion; a sound output portion which outputs a sound to the specific subject when the state of the specific subject is determined not to be a first state; and a shooting portion which shoots a target image when the state of the specific subject is determined to be the first state.

### BRIEF DESCRIPTION OF THE DRAWINGS

FIG. 1 is a block diagram schematically showing the configuration of an image sensing device according to a first embodiment of the present invention;

FIG. 2 is a flowchart schematically showing a basic operation that is performed by the image sensing device of the present invention when a moving image is shot;

FIG. 3 is a block diagram schematically showing the internal configuration of a specific subject detection portion shown in FIG. 1 and a perimeter portion of the specific subject detection portion;

FIG. 4 is a diagram showing an example of hierarchical images obtained by a reduced-image generation portion of FIG. 3;

FIG. 5 is a diagram showing processing operations in subject detection processing;

FIG. 6 is a diagram showing an example of a shooting region captured by the image sensing device;

FIG. 7 is a diagram showing an example of a table structure;

FIG. 8 is a flowchart showing processing operations in a front face shooting mode according to the first embodiment of the present invention;

FIG. 9 is a flowchart showing the processing operations in front face shooting processing according to the first embodiment of the present invention;

FIG. 10 is a block diagram schematically showing the configuration of an image sensing device according to a second embodiment of the present invention;

FIG. 11 is a diagram showing processing operations in face detection processing;

FIG. 12 is a block diagram schematically showing the internal configuration of a similarity measure determination portion shown in FIG. 10;

FIG. 13 is a flowchart showing processing operations in a front face shooting mode according to the second embodiment of the present invention; and

FIG. 14 is a diagram showing a plurality of input images arranged chronologically.

### DETAILED DESCRIPTION OF PREFERRED EMBODIMENTS

### First Embodiment

A first embodiment in which the present invention is applied to an image sensing device such as a digital camera that can shoot a still image will be described with reference to the accompanying drawings. As long as the image sensing device can shoot a still image, the image sensing device may be one that can shoot a moving image. In the referenced drawings, like parts are identified with like symbols, and their description will not be repeated in principle (the same is true in a second embodiment, which will be described later).

(Configuration of the Image Sensing Device)

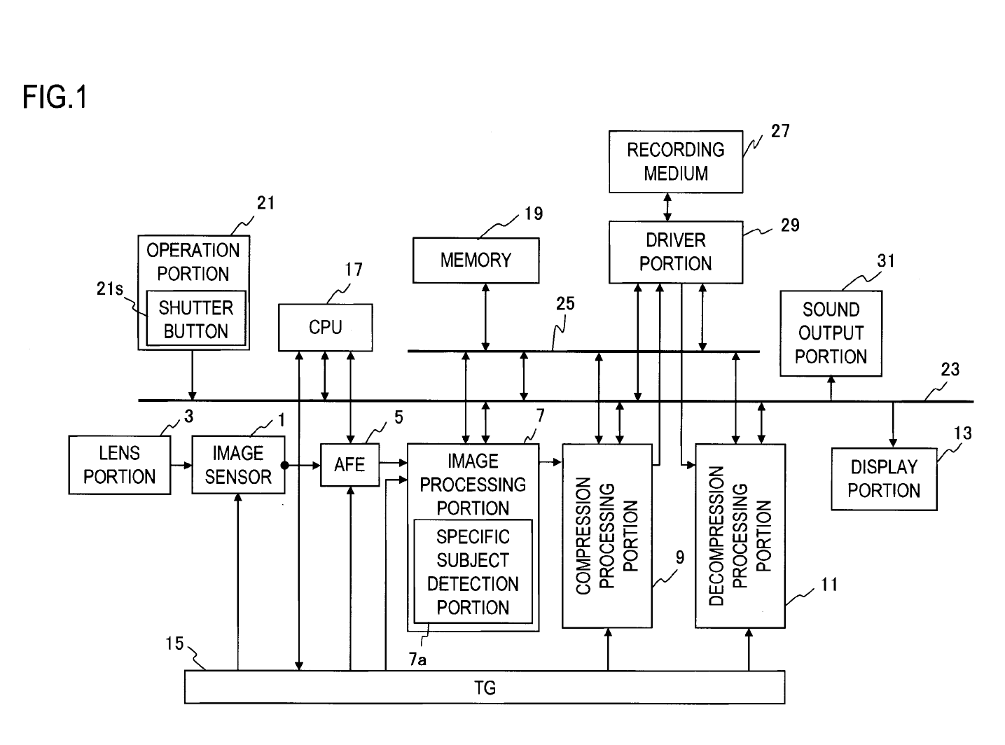

FIG. 1 is a block diagram schematically showing the configuration of the image sensing device according to the present embodiment. The image sensing device includes: a solid state image sensor (image sensor) 1 such as a CCD (charge coupled device) or a CMOS (complementary metal oxide semiconductor) sensor that converts incident light into an electrical signal; and a lens portion 3. The lens portion 3 includes: a zoom lens that forms an optical image of a subject on the image sensor 1; a motor that varies the focal length of the zoom lens, that is, that varies an optical zoom magnification; and a motor that focuses the focal point of the zoom lens on the subject.

The image sensing device of FIG. 1 further includes: an AFE (analog front end) 5 that converts an analog image signal output from the image sensor 1 into a digital image signal; an image processing portion 7 that performs various types of image processing such as gradation correction on the digital image signal from the AFE 5; and a compression processing portion 9 that performs compression encoding processing. When a still image is shot, the compression processing portion 9 performs compression encoding processing on an image signal from the image processing portion 7, using a JPEG (joint photographic experts group) compression format or the like. When a moving image is shot, the compression processing portion 9 performs compression encoding processing on the image signal from the image processing portion 7 and a sound signal output from a sound processing portion (not shown) including a sound microphone, using an MPEG (moving picture experts group) compression format or the like. The image sensing device of FIG. 1 further includes: a driver portion 29 that records, in a recording medium 27 such as an SD memory card, the signal compressed and encoded by the compression processing portion 9; a decompression processing portion 11 that decompresses and decodes the compressed and encoded signal read by the driver portion 29 from the recording medium 27; and a display portion 13 that has a LCD (liquid crystal display) or the like for displaying an image based on the image signal decoded by the decompression processing portion 11.

The image sensing device of the present embodiment further includes: a timing generator (TG) 15 that outputs a timing control signal for synchronizing the operation timing of the individual blocks within the image sensing device; a CPU (central processing unit) 17 that controls overall driving operation within the image sensing device; a memory 19 in which programs for individual operations are stored and data is temporarily stored when the programs are executed; an operation portion 21, including a shutter button 21s for shooting a still image, to which an instruction from a user is input; and a sound output portion 31, including a speaker (not shown), that outputs sound.

The image sensing device of the present embodiment further includes: a bus 23 through which data is exchanged between the CPU 17 and the individual blocks within the image sensing device; and a bus 25 through which data is exchanged between the memory 19 and the individual blocks within the image sensing device.

The CPU 17 drives the motors within the lens portion 3 according to the image signal detected with the image processing portion 7, and thus achieves control on a focal point and an aperture. The image processing portion 7 also includes a specific subject detection portion 7a that detects a specific subject (for example, a person or an animal) from an image corresponding to the image signal output from the AFE 5.

The image sensing device of FIG. 1 can periodically shoot a subject at a predetermined frame period. A sheet of an image (still image) represented by image signals of a frame period output from the AFE 5 is referred to as a frame image. A sheet of an image (still image) obtained by performing predetermined image processing on the image signals of a frame period output from the AFE 5 may be considered as the frame image.

The recording medium 27 may be either an optical disc such as a DVD (digital versatile disc) or a magnetic recording medium such as a HDD (hard disk drive).

(Basic Operation of the Image Sensing Device at the Time of Shooting)

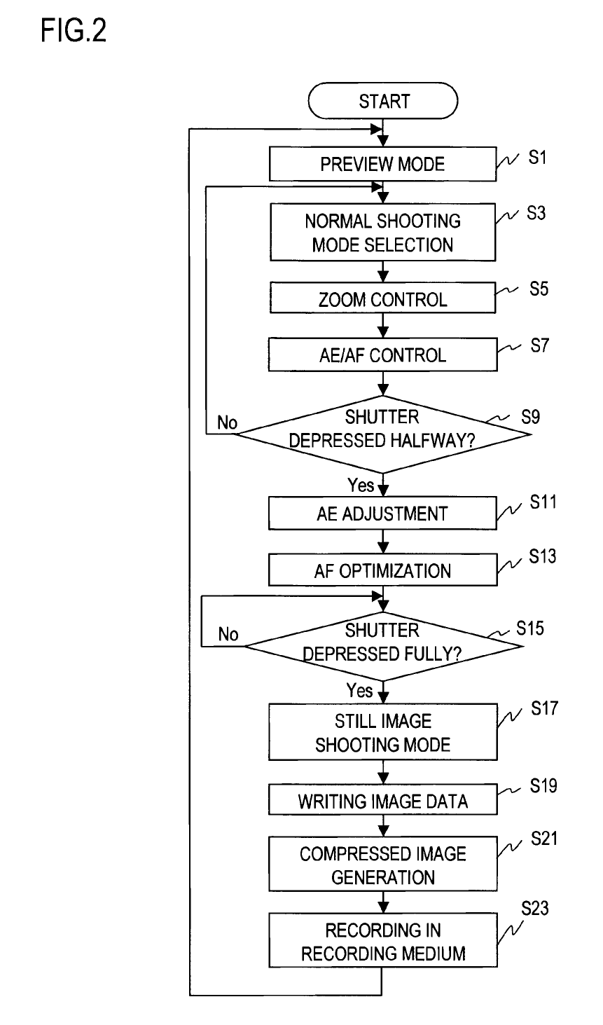

The basic operation of the image sensing device of FIG. 1 when a still image is shot will now be described with reference to FIG. 2, using its flowchart. When the user turns on the power supply of the image sensing device, the driving mode of the image sensing device, that is, the driving mode of the image sensor 1 is set to a preview mode (step Si). The preview mode is a mode in which an image of a target to be shot is displayed on the display portion 13 without being recorded. The preview mode can be used so that a target to be shot and its composition are determined. Then, the image sensing device is placed on standby for input of a shooting mode, and a mode corresponding to the functions of the image sensing device and a shoot scene is selected such as a mode suitable for shooting a person, a mode suitable for shooting a moving object or a mode suitable for shooting against the sun. When a shooting mode is not input, a normal shooting mode may be selected. In the example of FIG. 2, the normal shooting mode is selected (step S3).

In the preview mode, the analog image signal obtained by photoelectric conversion of the image sensor 1 is converted by the AFE 5 into the digital image signal. The digital image signal thus obtained is subjected to image processing, such as color separation, white balance adjustment and YUV conversion, that is performed by the image processing portion 7, and is then written into the memory 19. The image signals written into the memory 19 are sequentially displayed on the display portion 13. Consequently, frame images, each indicating a shooting region per predetermined period (for example, per 1/30 second or per 1/60 second) are sequentially displayed as preview images on the display portion 13. The shooting region refers to a shooting region in the image sensing device.

Then, the user sets an optical zoom magnification such that the desired angle of view is formed with respect to a subject which is a target to be shot (in other words, the subject which is the target to be shot is taken at the desired angle of view) (step S5). Here, the lens portion 3 is controlled by the CPU 17 based on an image signal input to the image processing portion 7. The control performed by the CPU 17 on the lens portion 3 includes AE (automatic exposure) control and AF (automatic focus) control (step S7). The optimum exposure is achieved by the AE control; the optimum focusing is achieved by the AF control. When the angle of view for shooting and the composition are determined by the user, and the shutter button 21s of the operation portion 21 is depressed halfway by the user (yes in step S9), AE adjustment is performed (step S11), and AF optimization processing is performed (step S13).

Thereafter, when the shutter button 21s is fully depressed (yes in step S15), the timing control signal is fed by the TG 15 to each of the image sensor 1, the AFE 5, the image processing portion 7 and the compression processing portion 9 to synchronize their operation timing. After the shutter button 21s is fully depressed, the driving mode of the image sensor 1 is set to a still image shooting mode (step S17), the analog image signal output from the image sensor 1 is converted by the AFE 5 into the digital image signal, and the digital image signal is written into a frame memory within the image processing portion 7 (step S19). The digital image signal is read from the frame memory, and various types of image processing such as signal conversion processing for generating a brightness signal and a color-difference signal are performed by the image processing portion 7. The digital image signal that has undergone these types of image processing is compressed by the compression processing portion 9 into a signal in the JPEG (joint photographic experts group) format (step S21). A compression image (image represented by the compressed digital image signal) obtained by the above compression is written into the recording medium 27 (step S23), and thus the shooting of the still image is completed. Thereafter, the mode returns to the preview mode.

(Basic Operation of the Image Sensing Device at the Time of Image Reproduction)

When an instruction to reproduce an image (still image or moving image) recorded in the recording medium 27 is given through the operation portion 21 to the image sensing device, a compressed signal of an image that is selected to be reproduced is read by the driver portion 29 and is fed to the decompression processing portion 11. The compressed signal fed to the decompression processing portion 11 is decompressed and decoded by the decompression processing portion 11 based on a compression encoding format, and thus an image signal is acquired. Then, the image signal thus obtained is fed to the display portion 13, and thus the image that is selected to be reproduced is reproduced. In other words, the image based on the compressed signal recorded in the recording medium 27 is reproduced.

(Subject Detection Processing)

Subject detection processing performed by the image sensing device of FIG. 1 will be described. The image sensing device of the present embodiment includes the specific subject detection portion 7a, and can detect, from an image signal that has been input, a specific subject such as the face of a person or the face of an animal; this detection is achieved by the subject detection processing. In the following description, the subject detection processing is also referred to as specific subject detection processing. The face of a person or the face of an animal can be regarded as a specific subject; a person himself or an animal itself can be regarded as a specific subject. It can be considered that persons belong to animals. Here, it is, however, considered that persons are not included in animals. The image signal of an arbitrary frame image can be input to the specific subject detection portion 7a; the specific subject detection portion 7a can detect a specific subject from the image signal of the frame image. In the following description, a frame image on which the subject detection processing can be performed is also particularly referred to an input image. Here, the configuration and the operation of the specific subject detection portion 7a will be described below, particularly using an example in which the face of a person is detected.

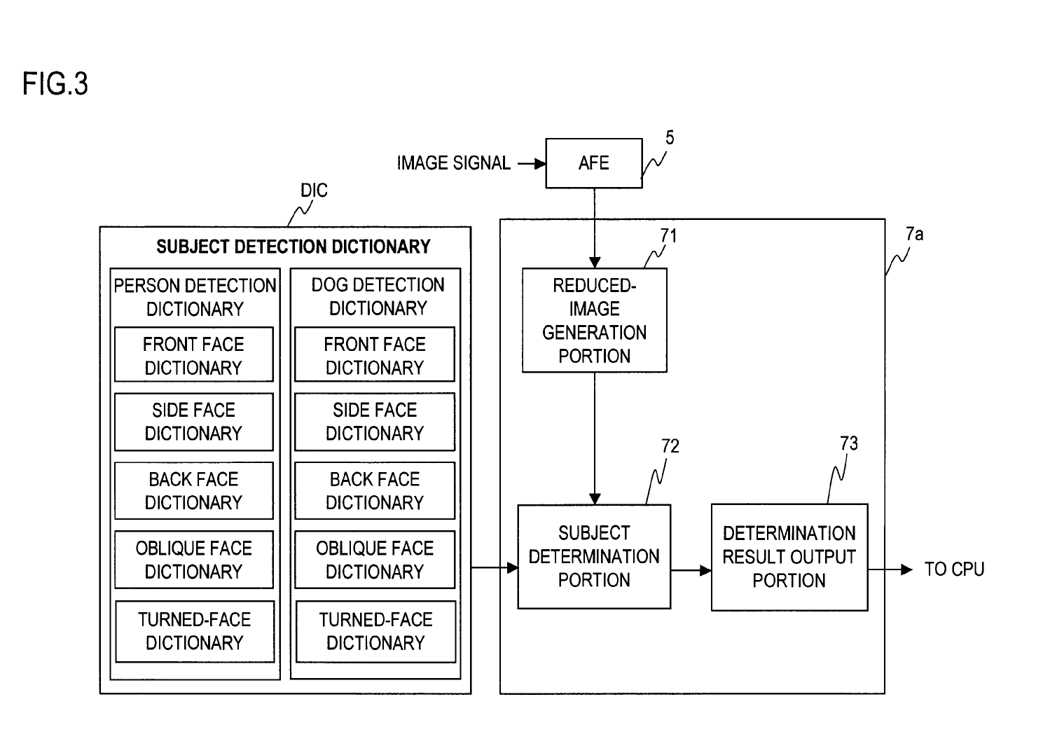

FIG. 3 is a block diagram schematically showing the configuration of the specific subject detection portion 7a. The specific subject detection portion 7a includes a reduced-image generation portion 71, a subject determination portion 72 and a determination result output portion 73. Based on the image signal obtained by the AFE 5, the reduced-image generation portion 71 produces one or a plurality of reduced images (that is, produces one or a plurality of sheets of reduced images which are images obtained by reducing an input image). The subject determination portion 72 uses a plurality of hierarchical images composed of an input image and reduced images obtained by reducing the input image and a subject detection dictionary DIC that is a weight table stored in the memory 19 and used for detection of a specific subject, and thus determines whether or not a specific subject is present in the input image. The determination result output portion 73 outputs the result of the determination by the subject determination portion 72 to the CPU 17 and the like. The subject detection dictionary DIC may be stored in the recording medium 27.

In the subject detection dictionary DIC stored in the memory 19, a plurality of edge feature images are defined (in other words, a plurality of edge feature images are included). The edge feature image refers to an image obtained by extracting only the edge portion of an image. The plurality of edge feature images include, for example, a horizontal direction edge image obtained by extracting only an edge portion in a horizontal direction and a vertical direction edge image obtained by extracting only an edge portion in a vertical direction. Each edge feature image is as large as a determination region that is used for detecting a specific subject from an input image. For each type of edge feature image, the subject detection dictionary DIC defines the position of each pixel of the edge feature image using the row number and column number of each pixel of the edge feature image.

Such a subject detection dictionary DIC is determined from a large number of teacher samples (such as facial and non-facial sample images in the case of, for example, a dictionary for detecting faces). Such a subject detection dictionary DIC can be made by utilizing, for example, a known learning method called “Adaboost” (Yoav Freund, Robert E. Schapire, “A decision-theoretic generalization of on-line learning and an application to boosting”, European Conference on Computational Learning Theory, Sep. 20, 1995). For example, a front face dictionary for detecting a front face, a side face dictionary for detecting a side face and other dictionaries are individually produced, and they can be included in the subject detection dictionary DIC.

In addition to dictionaries for persons, for example, dictionaries for detecting animals such as a dog and a cat, dictionaries for detecting an automobile and the like and other dictionaries are produced, and they can be included in the subject detection dictionary DIC.

The “Adaboost” is one of adaptive boosting learning methods in which, based on a large number of teacher samples, a plurality of weak classifiers that are effective for distinction are selected from a plurality of weak classifier candidates, and in which the selected weak classifiers are weighed and integrated to provide a high accuracy classifier. Here, the weak classifier refers to a classifier that performs classification more accurately than completely accidental classification but that does not have a sufficiently high accuracy. When weak classifiers are selected, if there already exist selected weak classifiers, learning can be intensively performed on teacher samples that erroneously carry out recognition depending on the already selected classifiers. Thus, it is possible to select the most effective weak classifier from the remaining weak classifier candidates.

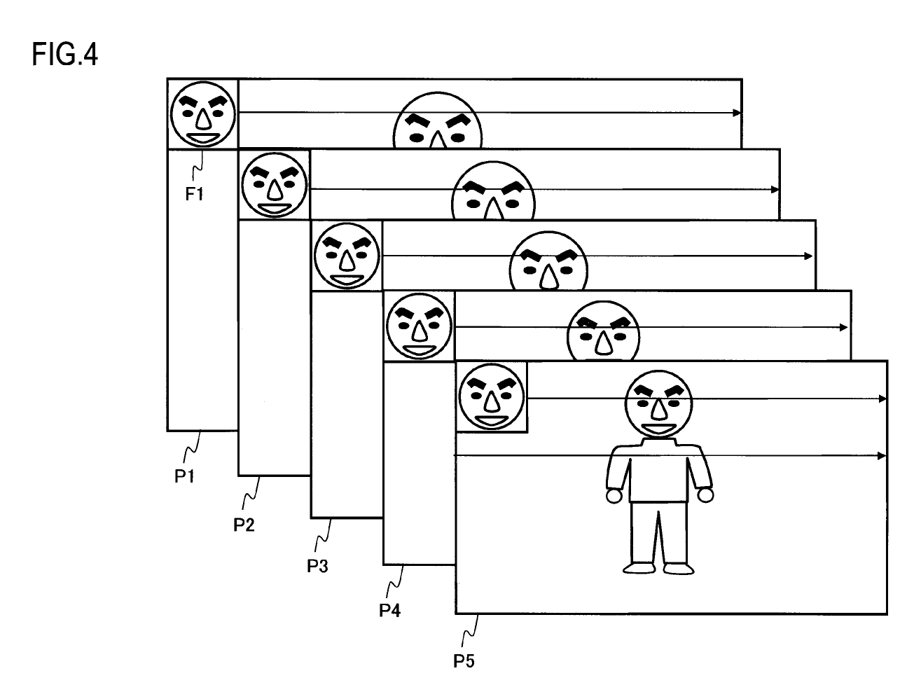

FIG. 4 shows an example of hierarchical images obtained by the reduced-image generation portion 71. The hierarchical images include an image obtained by reducing, by an arbitrary reduction factor R, an image acquired by the image sensing device; a plurality of different reduction factors R are used and thus it is possible to produce a plurality of hierarchical images. Here, an inequality “0<R<1” is satisfied. Ideally, the reduction factor R is preferably set to a value, such as 0.8 or 0.9, that is close to 1. In FIG. 4, symbol P1 represents an input image, and symbols P2, P3, P4 and P5 respectively represent images obtained by reducing the input image P1 by factors of R, R², R³ and R⁴. The images P1 to P5 function as five sheets of hierarchical images. Symbol F1 represents the determination region. The determination region is set such that the determination region, for example, is 24 pixels vertically by 24 pixels horizontally. In the input image and its reduced images, determination regions are equal in size to each other. The subject detection processing is performed using a plurality of edge feature images corresponding to the determination region set for each of the hierarchical images and dictionaries included in the subject detection dictionary DIC.

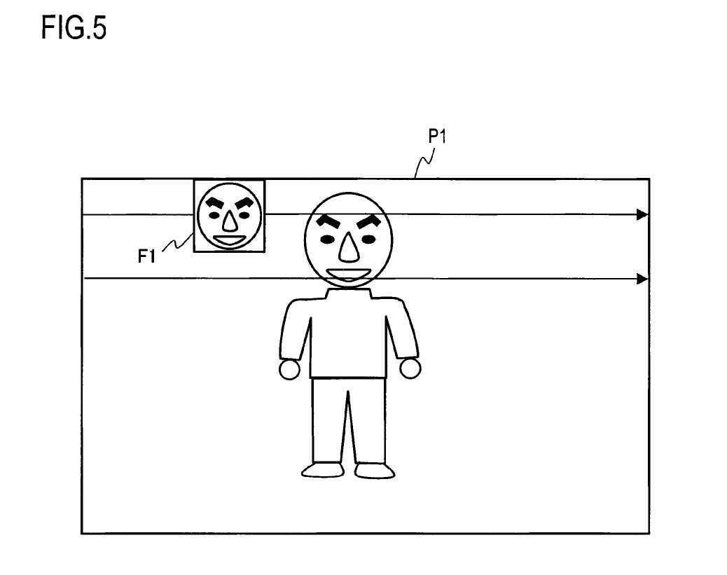

In the present embodiment, as indicated by each arrow of FIG. 4, the determination region is moved from left to right on each of the hierarchical images (the same is true in FIG. 5, which will be described later). Pattern matching is conducted while horizontal scanning of the determination region is being performed from the upper portion to the lower portion of the image, and thus a specific subject is detected. The order in which the scanning is performed is not limited to the order described above. Based on a similarity measure between each determination region (an image within each determination region) and each of the dictionaries included in the subject detection dictionary DIC, whether or not the determination region is a face region is detected. The face region refers to an image region (in other words, an image region where an image signal of a face is present) where an image of a face is present.

The reason why a plurality of reduced images P2 to P5 are produced in addition to the input image P1 is that a plurality of faces of different sizes are detected.

FIG. 5 is a diagram that illustrates the subject detection processing. The subject detection processing performed on the hierarchical images includes face detection processing for detecting a face (face region) from the hierarchical images. The subject detection processing performed by the subject determination portion 72 is conducted on each of the hierarchical images; the method of performing the subject detection processing is the same in all the hierarchical images, and hence only the subject detection processing performed on the input image P1 will be described here.

In FIG. 5, the input image P1 and the determination region F1 set within the input image P1 are shown. The face detection processing performed on each of the hierarchical images is conducted by pattern matching using an image corresponding to the determination region F1 set within the image and the subject detection dictionary DIC. The pattern matching refers to detection of whether the same pattern as set in the subject detection dictionary DIC or a pattern similar to that set in the subject detection dictionary DIC is present in the input image P1. For example, in the pattern matching, the subject detection dictionary DIC is moved while being overlaid on the input image P1, and whether or not two images (an image defined by the dictionary DIC and an image within the determination region F1) have a correlation (similarity) on a pixel data level is checked. The correlation between the input image P1 and the subject detection dictionary DIC is checked by, for example, similarity measure determination. The similarity measure determination is performed using a method of calculating a similarity measure, described in, for example, “digital image processing” (second edition, which is published by CG-ARTS Society on Mar. 1, 2007). The similarity measure can be derived using, for example, SSD (sum of squared difference), SAD (sum of absolute difference) or NCC (normalized cross-correlation). When the SSD or the SAD is used, the value of the similarity measure is decreased as similarity between compared images is increased whereas, if the value of the similarity measure is equal to or less than a predetermined threshold value, the corresponding determination region F1 is determined to be a face region. When the NCC is used, the similarity measure is increased as the cosine of an angle formed by vectors corresponding to the NCC is closer to 1, whereas, if the absolute value of a value obtained by subtracting 1 from the value of the similarity measure is equal to or less than a predetermined threshold value, the corresponding determination region F1 is determined to be a face region.

The subject detection processing is composed of a plurality of determination steps in which determinations are sequentially changed from rough determination to fine determination; if a specific subject is not detected at a given determination step, the process does not proceed to the subsequent determination step, and a specific subject is determined not to be present in the determination region of interest. Only if a specific subject is detected in all the determination steps, a face is determined to be present as the specific subject in the determination region. Then, a determination region is scanned, and thus the process proceeds to determination that is performed on the subsequent determination region. Such subject detection processing is disclosed in detail in JP-A-2007-257358; the method disclosed therein can be applied to the present embodiment.

Although the above description discusses the method of detecting a specific subject using the example in which the face of a person is detected, a specific subject (for example, the face of an animal, an animal itself or an automobile) other than the face of a person can also be detected by such a method.

As shown in FIG. 3, the image sensing device (subject detection dictionary DIC) of the present embodiment includes a person detection dictionary for detecting the face of a person and a dog detection dictionary for detecting the face of a dog. Each of the person detection dictionary and the dog detection dictionary includes: a front face dictionary for detecting a front face that is a face pointing frontward; a side face dictionary for detecting a side face that is a face pointing sideward; a back face dictionary for detecting a back face that is a face pointing backward; an oblique face dictionary for detecting an oblique face that is a face pointing obliquely; and a turned-face dictionary for detecting a turned face that is a face which has been turned.

When an image of a face on the input image is the same as that of the face which is observed as viewed from the front of the face, the side of the face or the back of the face, the face on the input image is a front face, a side face or a back face, respectively. When the direction of a center line (a line intersecting a glabella and the center of a mouth) of the face on the input image is inclined at a predetermined angle or more with respect to a reference direction on the input image, the face on the input image is an oblique face. Although, on the input image, the reference direction is usually a vertical direction, it may be a horizontal direction. When an image of the face on the input image is similar to an image obtained by turning a front face in a specific direction, the face on the input image is a turned face.

A state where a specific subject is detected with the front face dictionary is referred to as a state ST1; a state where a specific subject is detected with the side face dictionary is referred to as a state ST2; a state where a specific subject is detected with the back face dictionary is referred to as a state ST3; a state where a specific subject is detected with the oblique face dictionary is referred to as a state ST4; and a state where a specific subject is detected with the turned-face dictionary is referred to as a state ST5. The states ST1 to ST5 can be regarded as the respective states of a specific subject. The face of a specific subject on the input image P1 in the state ST1, the state ST2, the state ST3, the state ST4 or the state ST5 is a front face, a side face, a back face, an oblique face or a turned face, respectively.

(Front Face Shooting Mode)

The image sensing device of the present embodiment has the function of outputting sound and thus guiding a subject such as a person or an animal within a shooting region to point to the image sensing device. When the face of a specific subject that is a person or an animal points to the image sensing device, the face of the specific subject can be considered to be a front face; the image sensing device has a so-called front face shooting mode in which an image is automatically recorded at the moment when the face of the specific subject is changed to a front face.

For example, the front face shooting mode is achieved as follows. The user operates the operation portion 21 to set the shooting mode to the front face shooting mode, and then when the shutter button 21s is depressed halfway, the image sensing device 1 performs the AE adjustment and the AF optimization processing as in the normal shooting mode.

Thereafter, when the photographer fully depresses the shutter button 21s, the specific subject detection processing is performed on one or more input images including an image taken at the moment when the shutter button 21s is fully depressed, and the result of determination is output to the CPU 17. The result of determination, that is, the result of detection performed in the specific subject detection processing includes first information indicating whether or not a specific subject is present; when a specific subject is detected, second information indicating the state (ST1, ST2, ST3 ST4 or ST5) of the specific subject is further included in the result of detection performed in the specific subject detection processing. The input image on which the specific subject detection processing is performed after the shutter button 21s is fully depressed is particularly referred to as an evaluation input image. The evaluation input image can be a preview image. The specific subject detection processing on the evaluation input image is performed based on the image signal of the evaluation input image, and the first information and the second information on the evaluation input image can be obtained by performing the specific subject detection processing on the evaluation input image.

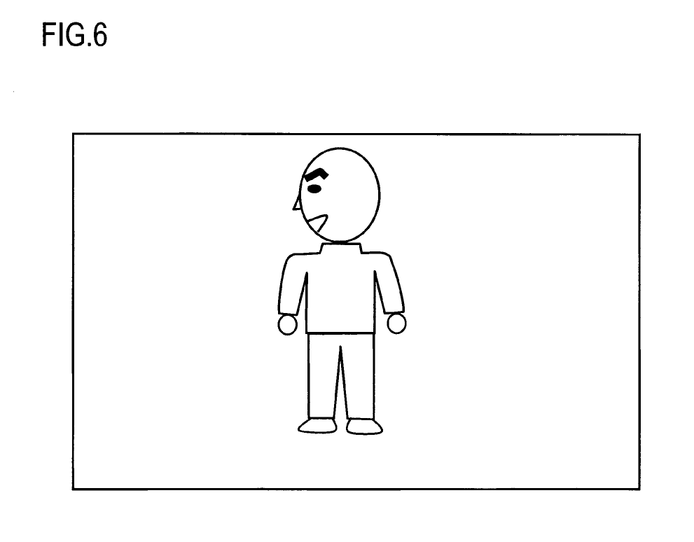

The detection of a specific subject means the detection of a specific subject from an input image. The detection of a specific subject may also be regarded as the detection of a specific subject from a shooting region. The first information described above is also considered to be information indicating whether or not a specific subject is detected from an evaluation input image or a shooting region; the second information described above is also considered to be information indicating which of the states ST1 to ST5 is the state of a specific subject detected from an evaluation input image or a shooting region. Both the determination of the type of specific subject such as the determination of whether or not a specific subject is a person and the determination of whether or not a specific subject is a dog and the determination of the state (any of ST1 to ST5) of a specific subject can be achieved by which of the face dictionaries is used to detect a specific subject. For example, when a specific subject is detected with the person detection dictionary, the type of specific subject is of a person; when a specific subject is detected with the dog detection dictionary, the type of specific subject is of a dog. For example, when a specific subject is detected with the front face dictionary, the state of the specific subject is the state ST1; when a specific subject is detected with the side face dictionary, the state of the specific subject is the state ST2. When a preview image as shown in FIG. 6 is an evaluation input image, the side face of a person is detected, and the state of the person that is the specific subject is determined to be the state ST2.

When the shutter button 21s is fully depressed, and then a specific subject is not detected, an image is shot without being processed, and the image signal (image data) of the image can be recorded in the recording medium 27.

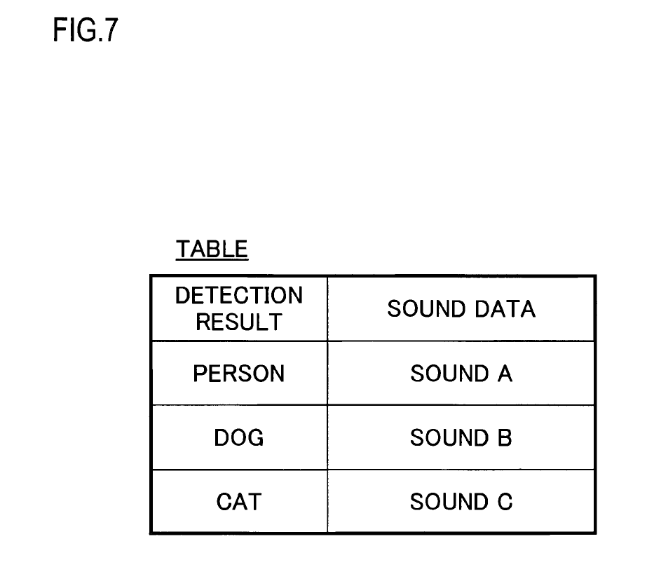

On the other hand, when a specific subject is detected, the CPU 17 determines, what sound is output, according to whether the detected specific subject is a person or a dog. The sound (its sound signal) may be stored in the memory 19 or in the recording medium 27. The sound is organized by, for example, a table as shown in FIG. 7; the sound that is output is determined according to the result of detection by the specific subject detection processing.

When a person is detected by the specific subject detection processing, a sound A for drawing the attention of the person and guiding the person to turn to face the image sensing device is output from the sound output portion 31. When a dog is detected by the specific subject detection processing, a sound B for guiding the dog to turn to face the image sensing device is output from the sound output portion 31. The sounds A and B and sounds C and D, which will be described later, can be set such that they differ from each other. The specific subject detection portion 7a uses a detection dictionary corresponding to a subject detected from a frame image (preview image) produced every predetermined period (when a specific subject is a person, the person detection dictionary is used; when a specific subject is a dog, the dog detection dictionary is used), and thus performs the specific subject detection processing. The output of sound and the specific subject detection processing are repeated until a front face of the specific subject is detected; during the reputation, when the state of the specific subject is changed to the state ST1, an image is recorded. When the image in the state ST1 is recorded in the recording medium 27, the shooting is completed. An input image (frame image) that is recorded in the recording medium 27 and that includes the image signal of a specific subject in the state ST1 is also particularly referred to as a target image.

When a specific subject is a dog, sound output from the sound output portion 31 is the sound B, and a dictionary used for detection of a specific subject is the dog detection dictionary. Except for these points, processing operations performed when a specific subject is a dog are the same as the above-described processing operations performed when a specific subject is a person.

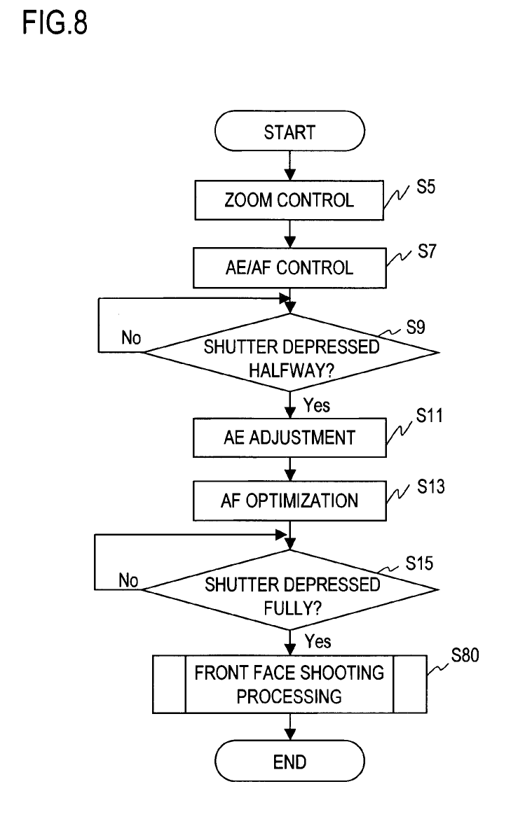

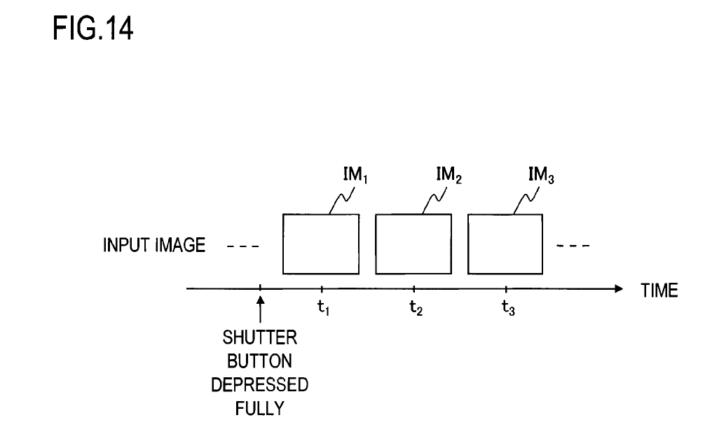

FIG. 8 is a flowchart showing processing operations performed by the image sensing device when a shooting mode is the front face shooting mode. In FIG. 8, the same processing operations as in the normal shooting mode described above are performed in steps identified by the same symbols as in the flowchart shown in FIG. 2, and hence their description will not be repeated. If the shutter button 21s is fully depressed in the front face shooting mode, processing in step S80 is performed. As a symbol that represents a time after the shutter button 21s is fully depressed, symbol tᵢ (i is an integer) is introduced. A time tᵢ₊₁ is a time that is behind the time tᵢ. As shown in FIG. 14, an input image obtained by performing shooting at the time tᵢ represented by symbol IMᵢ.

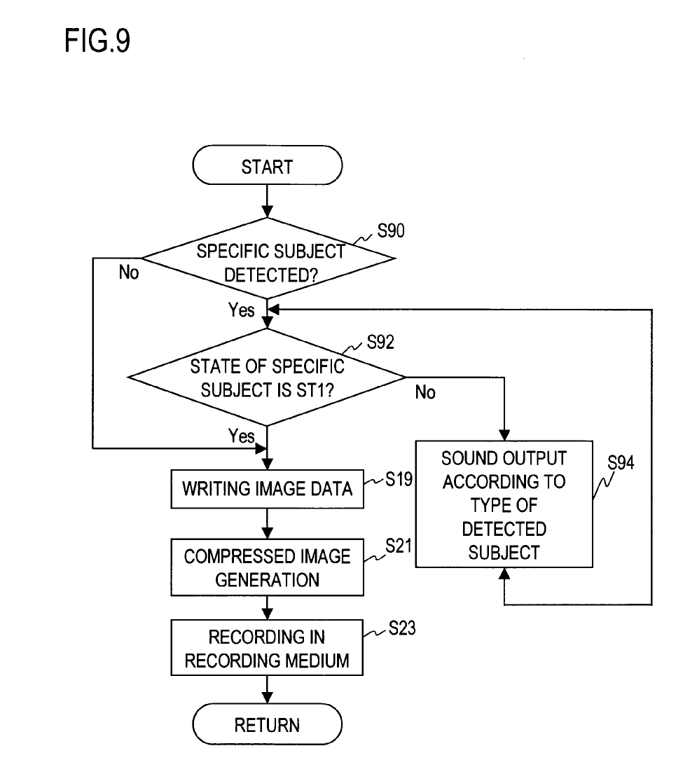

In step S80, front face shooting processing is performed. FIG. 9 is a flowchart showing processing operations in the front face shooting processing in step S80. The front face shooting processing is performed by the following subroutine that starts from step S90.

In the front face shooting processing, the input image IM₁ is first regarded as an evaluation input image in step S90, and whether or not a specific subject is detected from the evaluation input image IM₁ (from the shooting region at the time t₁) is determined by performing the subject detection processing on the evaluation input image IM₁. If a specific subject is detected, the process proceeds to step S92. If a specific subject is not detected, the process proceeds to step S19, and processing in steps S19, S21 and S23 is performed on the input image IM₁. Consequently, the input image IM₁ (specifically, an image obtained by compressing the input image IM₁) is recorded in the recording medium 27.

In step S92, the latest input image IMᵢ that has been obtained up to that time is regarded as an evaluation input image, and whether or not the state of a specific subject in the evaluation input image IMᵢ (in other words, the state of the specific subject at the time tᵢ) is the state ST1 (front face) is determined by performing the subject detection processing on the evaluation input image IMᵢ. If the state of the specific subject is the state ST1, the process proceeds to step S19 whereas, if it is not the state ST1, the process proceeds to step S94. If the state of the specific subject in the evaluation input image IMᵢ is determined to be the state ST1, the processing in steps S19, S21 and S23 is performed on the input image IMᵢ or IMᵢ₊₁. Consequently, the input image IMᵢ or IMᵢ₊₁ (specifically, an image obtained by compressing the input image IMᵢ or IMᵢ₊₁) is recorded as the target image in the recording medium 27.

In step S94, sound that is output is determined according to the type of specific subject detected in step S90, and the determined sound is output from the sound output portion 31. After the output of the sound, the process returns to step S92. In the i-th processing in step S92, the input image IMᵢ can be set to the evaluation input image.

The input image IMᵢ on which the subject detection processing is performed in steps S90 and S92 described above also functions as a preview image, and a plurality of input images including the input image IMᵢ are sequentially displayed on the display portion 13. The preview image can be considered to be an input image which is obtained by shooting performed before the target image is shot and from which a specific subject needs to be detected. It is also considered that, since the state of a specific subject is determined to be the state ST1, and then the latest input image (frame image) is recorded as the target image, a shooting portion of the image sensing device shoots the target image if the state of a specific subject is determined to be the state ST1. The shooting portion includes at least the image sensor 1 and the lens portion 3. The image processing portion 7 (for example, the specific subject detection portion 7a) includes: a subject detection portion that detects a specific subject from an input image (for example, a preview image); a state determination portion that determines the state of a specific subject detected by the subject detection portion; and a subject type determination portion that determines the type of specific subject on the input image. Their functions are achieved by the specific subject detection processing. The image sensing device (for example, the CPU 17) includes a sound type determination portion that determines the type of sound that is output from the sound output portion 31 according to the result of determination by the subject type determination portion.

In the embodiment described above, when a specific subject is not detected in the specific subject detection processing performed after the shutter button 21s is fully depressed, an image is recorded without being processed. Alternatively, for example, when the shutter button 21s is fully depressed, the specific subject detection processing may be repeatedly performed in a predetermined period. In this case, if a specific subject is detected during the predetermined period, the front face shooting processing described above may be performed. In the present specification, the simple expression “recording” may be considered to indicate recording in the recording medium 27, and the expression “recording of an image” may be considered to indicate recording of an input image, a frame image or the target image in the recording medium 27.

Although, in the embodiment described above, only an image in which the state of a specific subject is the state ST1 is recorded, an image may be recorded at each predetermined timing until a specific subject is changed to a front face. For example, an image may be recorded every predetermined period until a specific subject is changed to a front face, or an image may be recorded each time the state of a specific subject is changed.

Information on the face of a predetermined subject and a predetermined sound D may be previously stored in the memory 19 or the recording medium 27. When a specific subject is detected, and then the specific subject is determined by the similarity measure determination to be similar to the predetermined subject that is previously recorded, the sound D may be output.

Although, in the embodiment described above, the state is continuously determined until the shooting of the target image is completed, the state may be determined intermittently, that is, for example, every ten frames. In all cases, the state of a specific subject on the evaluation input image IMᵢ can be determined repeatedly, that is, every predetermined period (can be determined repeatedly, that is, at predetermined intervals). This is true in the second embodiment, which will be described later. The timing of output of sound is the same as in the determination of the state, and the sound may be output either continuously or intermittently. In other words, until the shooting of the target image by the shooting portion is completed (until the state of a specific subject is determined to be the state ST1 in step S92), sound (the sound A or B in the present embodiment) may be output either continuously or intermittently. This is true in the second embodiment, which will be described later.

When a plurality of specific subjects are detected from the shooting region, an image may be recorded at the moment when the faces of all specific subjects are changed to front faces, or an image may be recorded at the moment when the face of any of the specific subjects is changed to a front face.

Alternatively, priorities are previously assigned to specific subjects, and, when a plurality of specific subjects are detected from the shooting region, an image may be recorded at the moment when the specific subject of high priority faces the front, or an image may be recorded at the moment when the face of a specific subject near the center of the shooting region is changed to a front face.

The above-described timings of recording of images may be arbitrarily selected or set by the photographer.

When both a person and a dog are detected from the shooting region, the sounds A and B may be simultaneously output, or the sounds A and B may be alternately output.

A sound that is output when both a person and a dog are detected may be additionally prepared.

With the same methods as in the examples described above, it is possible to reliably shoot, for example, a side face and a back face.

Although, in the examples described above, when the state of a specific subject is the state ST1 (front face), an image is recorded, an image may be recorded when the state of a specific subject is, for example, the state ST2 (side face), the state ST4 (oblique face) or the state ST5 (turned face), and the shooting may be completed at that point.

The user may arbitrarily set in what state of a specific subject an image is recorded.

### Second Embodiment

The second embodiment in which the present invention is applied to an image sensing device such as a digital camera that can shoot a still image will now be described with reference to the accompanying drawings. As long as the image sensing device can shoot a still image, the image sensing device may be one that can shoot a moving image. The second embodiment is based on the first embodiment; the description in the first embodiment can also be applied to what is not particularly described in the second embodiment unless a contradiction arises.

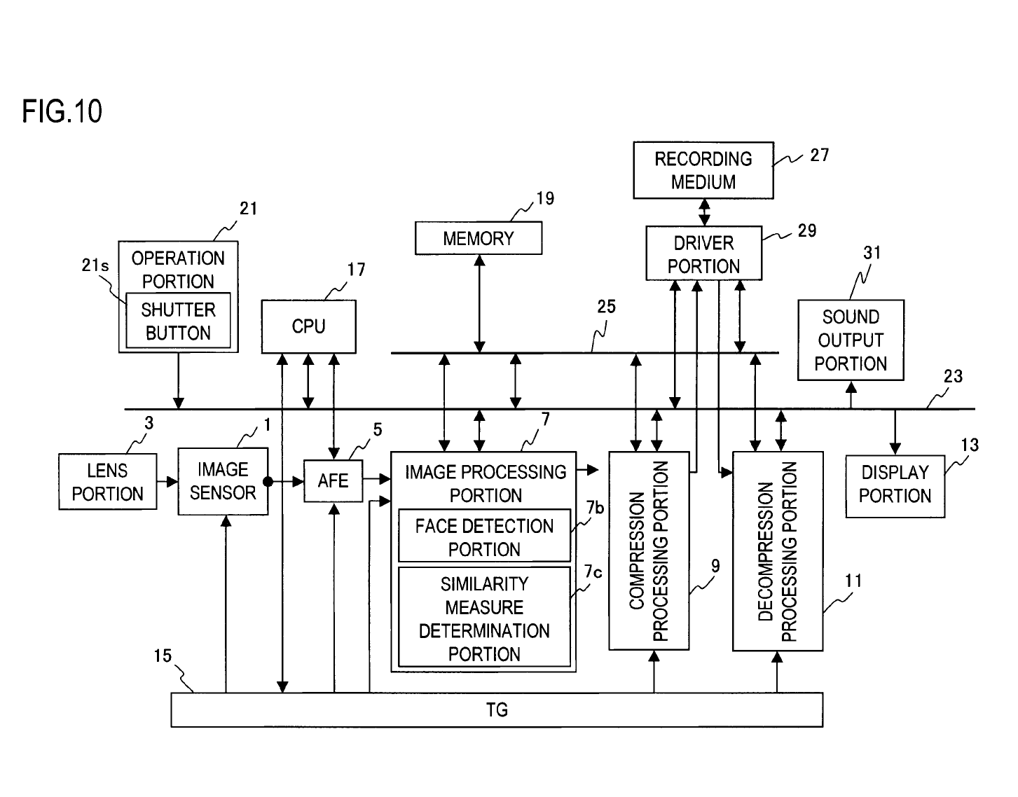

FIG. 10 is a block diagram schematically showing the configuration of the image sensing device according to the second embodiment of the present invention. In FIG. 10, parts that are identified with the same symbols as in the block diagram shown in FIG. 1 perform the same processing operations as described above, and hence their description will not repeated.

The image sensing device includes a face detection portion 7b that detects the face of a person and a similarity measure determination portion 7c that determines to what animal a face detected by the face detection portion 7b is similar. The image sensing device further includes animal detection dictionaries (not shown) for detecting animals. In the present embodiment, the dog detection dictionary for detecting dogs and a cat detection dictionary for detecting cats are assumed to be included as the animal detection dictionaries. As shown in FIG. 10, the face detection portion 7b and the similarity measure determination portion 7c can be provided in the image processing portion 7. The image sensing device of the second embodiment includes the individual portions shown in FIG. 1; although not shown in FIG. 10, the specific subject detection portion 7a of FIG. 1 can also be provided in the image processing portion 7 of the second embodiment. It may be considered that the specific subject detection portion 7a includes the face detection portion 7b and the similarity measure determination portion 7c.

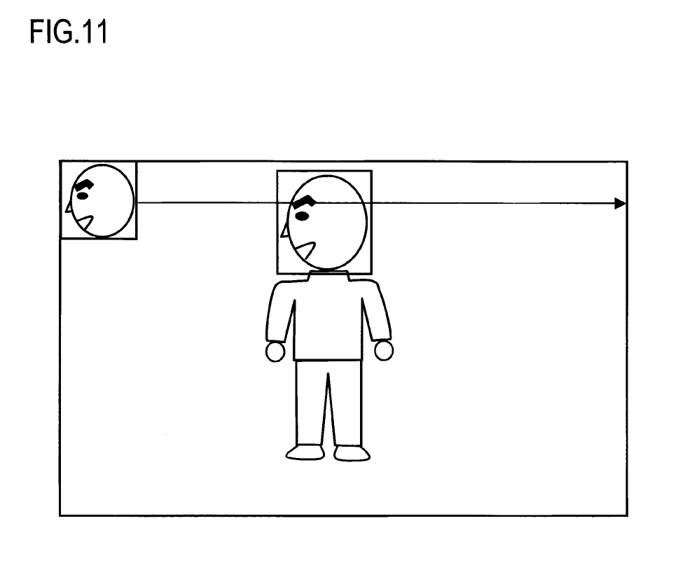

FIG. 11 shows a shooting region captured by the image sensing device. The user operates the operation portion 21, and thus the shooting mode is set to the front face shooting mode. When the shutter button 21s is depressed halfway, the image sensing device performs the AE adjustment and the AF optimization processing. Thereafter, when the shutter button 21s is fully depressed, the face detection processing is performed on the preview image, and the result of the detection is output to the similarity measure determination portion 7c. For example, when the face detection processing is performed on the preview image as shown in FIG. 11, the side face of a person is detected with the side face dictionary, and the result of the detection is output to the similarity measure determination portion 7c. The face detection processing can be performed by the face detection portion 7b based on the image signal of the preview image.

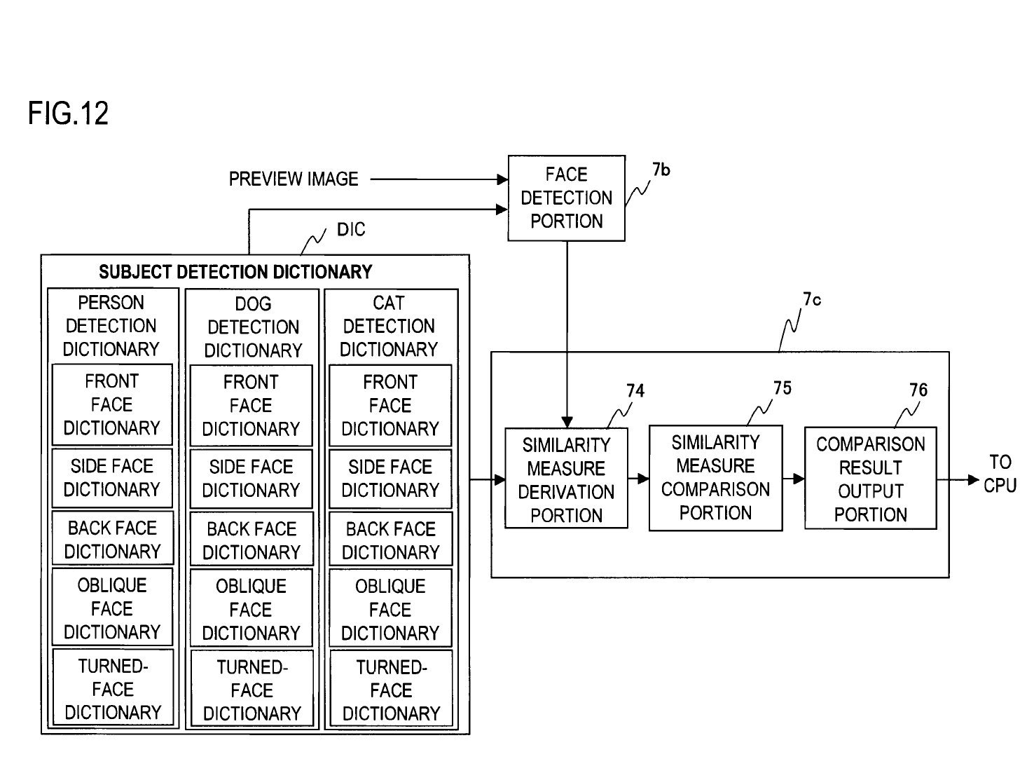

FIG. 12 is a block diagram schematically showing the internal configuration of the similarity measure determination portion 7c. The similarity measure determination portion 7c includes a similarity measure derivation portion 74, a similarity measure comparison portion 75 and a comparison result output portion 76. As shown in FIG. 12, in addition to the person detection dictionary and the dog detection dictionary, the subject detection dictionary DIC of the present embodiment includes the cat detection dictionary. The similarity measure derivation portion 74 derives similarity measures between a partial image and the animal detection dictionaries for detecting animals, and outputs the derived similarity measures to the similarity measure comparison portion 75. The partial image refers to an image of the face of a person detected by the face detection portion 7b as a specific subject; that image is also part of a preview image in which the face of the person is detected by the face detection processing. The similarity measure is derived for each of the animal detection dictionaries based on the image signal of the preview image in which the face of the person is detected. In the present embodiment, a similarity measure between the partial image and the dog detection dictionary and a similarity measure between the partial image and the cat detection dictionary are derived.

The similarity measure comparison portion 75 compares a plurality of similarity measures derived by the similarity measure derivation portion 74, and thus determines to what animal the face detected by the face detection processing is the most similar. In other words, based on the similarity measures derived by the similarity measure derivation portion 74, to what animal the person which is a specific subject is the most similar (in present embodiment, to which one of a dog and a cat the person is more similar) is determined. The comparison result output portion 76 outputs to the CPU 17 the result of the comparison (and the result of the determination) by the similarity measure comparison portion 75.

The CPU 17 determines, a sound that is output, based on the result of the comparison (and the result of the determination) output from the comparison result output portion 76. The sound (its sound signal) may be stored in the memory 19 or in the recording medium 27.

Thereafter, when the face of the person detected by the face detection processing is determined to be similar to a dog, the sound B, related to dogs, such as a dog's bark “bowwow” is output from the sound output portion 31; when the face of the person detected by the face detection processing is determined to be similar to a cat, the sound C, related to cats, such as a cat's crying sound “meow” is output from the sound output portion 31 (see FIG. 7). The specific subject detection portion 7a or the face detection portion 7b performs the face detection processing on a preview image produced every predetermined period, and determines whether or not the state of the face of the specific subject is the state ST1 (that is, front face), using the person detection dictionary when the detected specific subject is a person, the dog detection dictionary when the detected specific subject is a dog or the cat detection dictionary when the detected specific subject is a cat. This determination method is the same as described in the first embodiment. Then, when the state of the face of the specific subject is determined to be the state ST1, an image at that moment is recorded in the recording medium 27, and the sound output is completed. The sound output, the face detection processing and the processing for determining the state of the face of the specific subject are repeatedly performed until the state ST1 is detected.

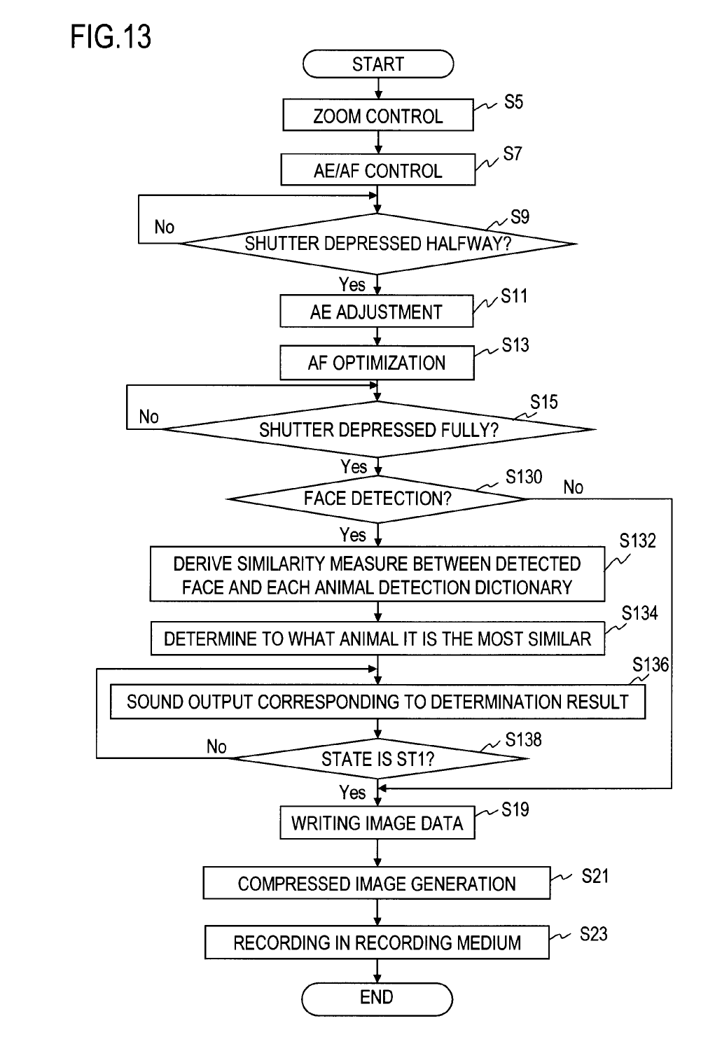

FIG. 13 is a flowchart showing processing operations performed by the image sensing device when the shooting mode is the front face shooting mode in the second embodiment of the present invention. In FIG. 13, the same processing operations as in the normal shooting mode described above are performed in steps identified by the same symbols as in the flowchart shown in FIG. 2, and hence their description will not be repeated. If the shutter button 21s is fully depressed in the front face shooting mode, processing in step S130 is performed.

In step S130, the input image IM₁ is regarded as an evaluation input image (see FIG. 14), and whether or not the face of a person is detected from the evaluation input image IM₁ (from the shooting region at the time t₁) is determined by performing the face detection processing on the evaluation input image IM₁. The person himself to be detected or the face of the person can be regarded as a specific subject. If the face of the person is detected, the process proceeds to step S132. If the face of the person is not detected, the process proceeds to step S19, and the processing in steps S19, S21 and S23 is performed on the input image IM₁. Consequently, the input image IM₁ (specifically, an image obtained by compressing the input image IM₁) is recorded in the recording medium 27.

In step S132, similarity measures between the face detected in step S130 and each of the animal detection dictionaries are derived, and, in step S134, based on the similarity measures derived in step S132, to what animal the face detected in step S130 is the most similar is determined. In the subsequent step S136, sound that is output is determined according to the result of the determination in step S134, and the sound is output from the sound output portion 31. For example, if the face detected in step S130 is determined to be the most similar to a dog, the sound B is output in step S136; if the face detected in step S130 is determined to be the most similar to a cat, the sound C is output in step S136.

In step 138 subsequent to step S136, the latest input image IMᵢ that has been obtained up to that time is regarded as an evaluation input image, and whether or not the state of the face of a specific subject in the evaluation input image IMᵢ (in other words, the state of the face at the time tᵢ) is the state ST1 is determined by performing the subject detection processing on the evaluation input image IMᵢ. If the state of the face of the specific subject is the state ST1, the process proceeds to step S19 whereas, if it is not the state ST1, the process returns to step S136. If the state of the face of the specific subject in the evaluation input image IMᵢ is determined to be the state ST1, the processing in steps S19, S21 and S23 is performed on the input image IMᵢ or IMᵢ₊₁. Consequently, the input image IMᵢ or IMᵢ₊₁ (specifically, an image obtained by compressing the input image IMᵢ or IMᵢ₊₁) is recorded as the target image in the recording medium 27.

The input image IMᵢ on which the face detection processing and the subject detection processing are performed in steps S130 and S138 described above also functions as a preview image, and a plurality of input images including the input image IMᵢ are sequentially displayed on the display portion 13. The similarity measure determination portion 7c is also considered to be a selection portion that selects, from a plurality of types of animals, an animal having a face similar to the face of the person detected by the face detection processing, or the similarity measure determination portion 7c is also considered to be a determination portion that determines an animal having a face similar to the face of the person detected by the face detection processing.

Although, in the examples described above, the sound is continuously output until the state of the face of a specific subject is changed to the state ST1, if the state of the face of the specific subject has not been changed to the state ST1 for a predetermined period, the output of the sound may be completed and the front face shooting processing (the operation of FIG. 13) may be stopped.

Dictionaries used for deriving similarity measures may be limited according to the state of a face detected by the face detection processing. Specifically, for example, when the state of a face detected by the face detection processing is the state ST2, a similarity measure may be derived using only the side face dictionary; when the state of the face is the state ST4, a similarity measure may be derived using only the oblique face dictionary. Thus, the amount of processing performed on the determination of a similarity measure is reduced, and it is therefore possible to determine a similarity measure in a shorter time.

Although, in the present embodiment, to what animal in the animal detection dictionaries the detected face of a person is the most similar is determined, a dictionary for detecting an object other than animals is prepared, and a similarity (similarity measure) between such a dictionary and the detected face of the person may be determined.

Since, in the present embodiment, the target image is not shot until the face of a subject is changed to the state ST1, that is, is changed to a front face, the state of the face may not be determined after the face detection, and the target image may be shot when a face is detected by performing the face detection with only the front face dictionary.

As in the first embodiment, information on the face of a predetermined subject and a predetermined sound D may be previously stored in the memory 19 or the recording medium 27. When a specific subject is detected, and then the specific subject is determined by the similarity measure determination to be similar to the predetermined subject that is previously recorded, the sound D may be output.

When a plurality of specific subjects are detected from the shooting region, an image may be recorded at the moment when the faces of all specific subjects are changed to front faces, or an image may be recorded at the moment when the face of any of the specific subjects is changed to a front face.

Alternatively, priorities are previously assigned to specific subjects, and, when a plurality of specific subjects are detected from the shooting region, an image may be recorded at the moment when the specific subject of high priority faces the front, or an image may be recorded at the moment when the face of a specific subject near the center of the shooting region is changed to a front face.

The above-described timings of recording of images may be arbitrarily selected or set by the photographer.

When a plurality of persons are detected from the shooting region, and the detected persons are determined to be similar to different animals, respectively, sounds corresponding to the results of the determinations may be simultaneously output, sounds corresponding to a plurality of animals may be alternately output or a sound that is additionally prepared may be output.

Although the examples of the embodiments of the present invention have been described, the present invention is not limited to these examples of the embodiments, and many variations and modifications are possible within the scope of the present invention.

In the embodiments described above, a specific subject is detected from a shooting region, and sound for guiding the specific subject to look to a camera is output. At that point, the sound that is output can be determined according to the type of specific subject. Then, an image is shot at the moment when the specific subject looks to the camera. It is therefore possible to shoot an image in which a subject looks to a camera without placing a burden on a photographer.

What is claimed is:

1. An image sensing device comprising:
a subject detection portion which detects a specific subject from a preview image;
a state determination portion which determines a state of the specific subject detected by the subject detection portion;
a sound output portion which outputs a sound to the specific subject when the state of the specific subject is determined not to be a first state; and
a shooting portion which shoots a target image when the state of the specific subject is determined to be the first state.

2. The image sensing device of claim 1,
wherein the state determination portion repeatedly determines the state of the specific subject every predetermined period.

3. The image sensing device of claim 1,
wherein the sound output portion continues to output the sound until the shooting of the target image by the shooting portion is completed.

4. The image sensing device of claim 1,
wherein the sound output portion intermittently outputs the sound until the shooting of the target image by the shooting portion is completed.

5. The image sensing device of claim 1, further comprising:
a subject type determination portion which determines a type of the specific subject; and
a sound type determination portion which determines, according to a result of the determination by the subject type determination portion, a type of the sound that is output from the sound output portion.

6. The image sensing device of claim 1,
wherein the subject detection portion includes:
a face detection portion which detects, from the preview image, a face of a person as the specific subject; and
a selection portion which selects, from a plurality of animals, an animal that is similar to the detected face of the person, and
a sound output portion outputs, as the sound, a sound corresponding to the selected animal.
